(19) United States
(12) Patent Application Publication
(10) Pub. No.: US 2024/0202644 A1
(43) Pub. Date: Jun. 20, 2024

(54) AUTOMATED PACKAGE DELIVERY IN A RISK-FREE WALKWAY

(71) Applicant: INTERNATIONAL BUSINESS MACHINES CORPORATION, ARMONK, NY (US)

(72) Inventors: Sudhanshu Sekher Sar, Bangalore (IN); Sudheesh S. Kairali, Kozhikode (IN); Sarbajit K. Rakshit, Kolkata (IN); Satyam Jakkula, Bengaluru (IN)

(21) Appl. No.: 18/066,832

(22) Filed: Dec. 15, 2022

(51) Int. Cl. G06Q 10/083

(52) U.S. Cl. CPC G06Q 10/083

(57) ABSTRACT

Techniques are described with respect to a system, method, and computer product for delivering package in a risk-free walkway. An associated method includes generating location profile associated with a location and analyzing a user profile associated with a user. The method further including determining an optimal path for delivery of package associated with the user based on the location profile and deploying a robot designed to utilize the optimal path to deliver package based on the user profile.

### BACKGROUND

The present invention relates to the electrical, electronic, and computer arts, and more specifically, to computer systems for automated package delivery in a risk-free walkway.

Viruses, diseases, and infectious bacteria pose a significant health hazard to people in frequently habited areas (e.g., airports, hospitals, shopping centers, etc.). A possible means to reduce the amount of exposure to the aforementioned health hazard is to reduce the amount of individuals in a confined space by allocating zoning within the confined space allowing a flow of pedestrian traffic free of congregation and collisions in addition to reduction of exposure to widespread biological contaminants.

In particular, airports, train stations, and other applicable transportation hubs are frequently exposed to significant health hazards due to the high volume of traffic consisting from people arriving and departing from all over the world. A common area within said transportation hubs which is highly susceptible to spreading of infectious diseases is the area of baggage/package retrieval (e.g., baggage claim, baggage carousel, etc.) due to the frequent congregation of individuals from different flights, trains, buses, etc.

### SUMMARY

Additional aspects and/or advantages will be set forth in part in the description which follows and, in part, will be apparent from the description, or may be learned by practice of the invention.

A system, method, and computer product for delivering package in a risk-free walkway is disclosed herein. In some embodiments, the computer-implemented method for delivering package in a risk-free walkway includes generating a location profile associated with a location; analyzing a user profile associated with a user; determining an optimal path for delivery of package associated with the user based on the location profile; and deploying a robot designed to utilize the optimal path to deliver package based on the user profile.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment, according to an exemplary embodiment;

FIG. 2 illustrates a package delivery system environment, according to an exemplary embodiment;

FIG. 3 illustrates a block diagram of various modules associated with the package delivery system of FIG. 2, according to an exemplary embodiment;

FIG. 4 illustrates a virtual zoned environment associated with the package delivery system of FIG. 2, according to an exemplary embodiment

FIG. 5 schematically illustrates a method for determining risk-free walkways with collision avoidance, according to an exemplary embodiment; and

FIG. 6 illustrates a flowchart depicting a method for delivering package in a risk-free walkway, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

As described herein, a “geofence” is a virtual perimeter or zone for a real-world geographic area or augmented environment configured to be dynamically generated and viewed via a computing device such as, but not limited to a computer-mediated reality device. In particular, geofences and areas within geofence boundaries are designated contamination zones.

As described herein, a “contamination zone” is an area with a detected presence or high probability of risk including but not limited to presence of infectious particles (e.g., viruses, harmful bacteria, etc.), active shooter, acts of intent, bomb threat, building move, chemical exposure, external, civil unrest, communication/telephony failure, dam failure, drought, earthquake, epidemic, evacuation, explosion, external flood, fire, flood, forensic admission, gas/emissions leak, generator failure, hazmat incident, hazmat incident with mass casualties, hostage situation, hurricane, HVAC failure, inclement weather, infectious disease outbreak, internal fire, internal flood, IT system outage, landslide, large internal spill, mass casualty incident, natural gas disruption, natural gas failure, other utility failure, pandemic, patient surge, picketing, planned power outages, power outage, radiation exposure, seasonal influenza, sewer failure, shelter in place, strikes/labor action/work stoppage, suicide, supply chain shortage/failure, suspicious odor, suspicious package/substance, temperature extremes, tornado, transportation failure, trauma, tsunami, VIP situation, water contamination, water disruption, weapon, or any other applicable risk known to those of ordinary skill in the art.

The following described exemplary embodiments provide a method, computer system, and computer program product for delivering package in a risk-free walkway. The following described exemplary embodiments provide a method, computer system, and computer program product for managing a risk-free walkway. The spreading of infectious bacteria/diseases is exacerbated by public spaces due to the inherent frequent foot traffic. In particular, transportation hubs (e.g., airports, train stations, bus stations, etc.), shopping centers, etc. have become hotbeds for spreading of infectious bacteria/diseases and specific areas within the aforementioned venues inherently have a higher risk of disease dissemination due to frequent congregation of individuals. For example, baggage/package retrieval areas (e.g., baggage claim, baggage carousel, etc.) are highly susceptible to spreading of infectious diseases due to the frequent congregation of individuals from different flights, trains, buses, etc. Therefore, the present embodiments have the capacity to reduce the amount of exposure to infectious bacteria/diseases within public spaces by classifying zones within a public venue and utilizing a robotic system to deliver package of travelers within zones classified as uncontaminated. Furthermore, the present embodiments generate risk-free walkways for travelers that facilitate risk-free arrival of individuals to destinations within public locations in a manner that circumvents collisions with and/or exposure to other travelers. Thus, the present embodiments improve the safety of travelers, and optimize inherently problematic situations in public venues such as the check-in process and the package retrieval process during travel.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch payment devices or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

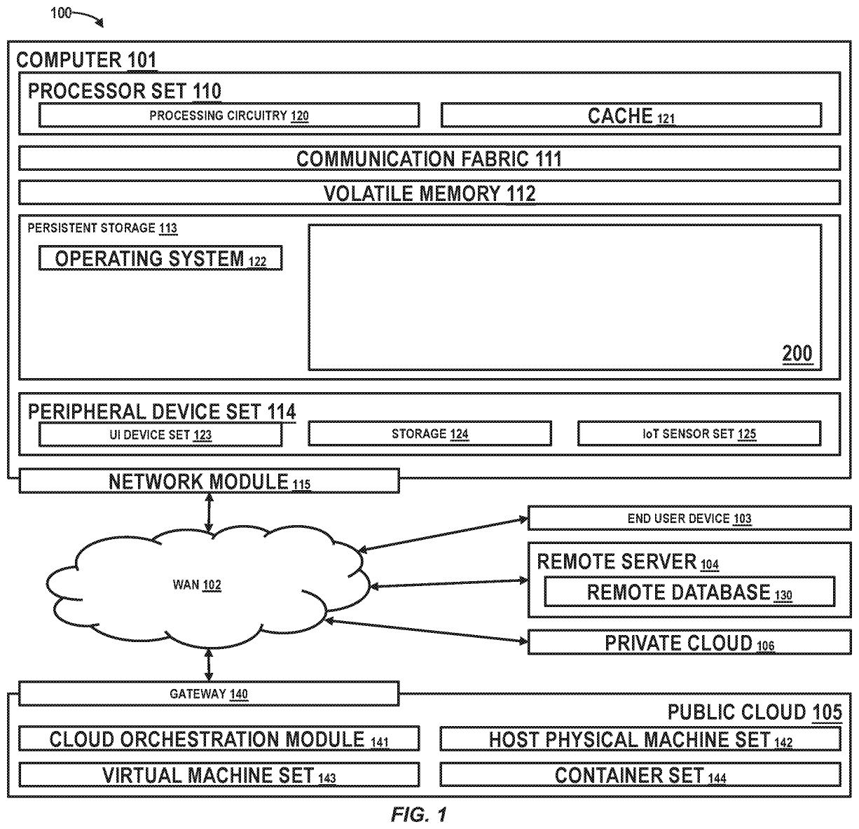

The following described exemplary embodiments provide a system, method and computer program product for delivering package in a risk-free walkway. Referring now to FIG. 1, a computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113, peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

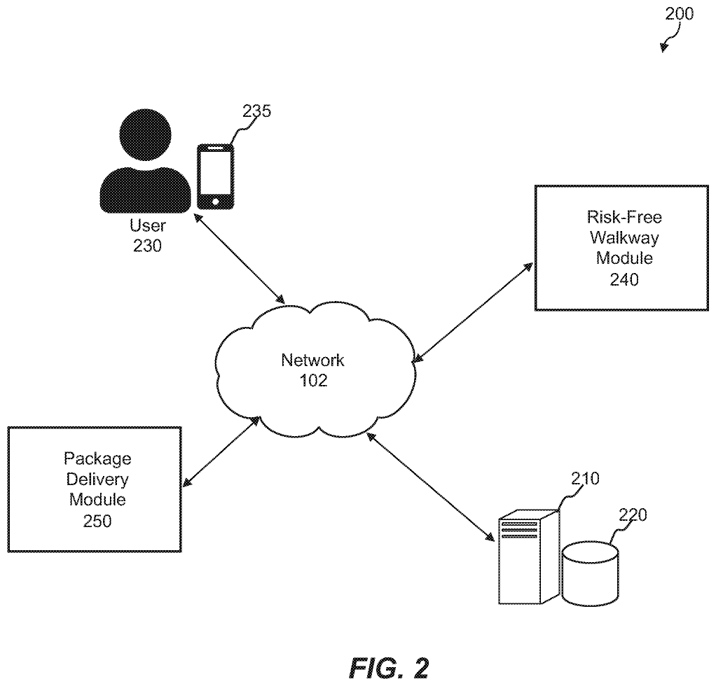

Referring now to FIG. 2, a functional block diagram of a networked computer environment illustrating a risk-free walkway management system 200 (hereinafter “system”) comprising a server 210 communicatively coupled to a database 220, a user 230 associated with a computing device 235, a risk-free walkway module 240, and a package delivery module 250, each of which are communicatively coupled over WAN 102 (hereinafter “network”) and data from the components of system 200 transmitted across the network is stored in database 220. Computing device 235 may take the form of a desktop computer, laptop computer, tablet computer, smart phone, smart watch or other wearable computer, computer-mediated reality device, mainframe computer, quantum computer or any other form of computer or mobile device now known or to be developed in the future that is capable of running a program, accessing a network or querying a database. It should be appreciated that FIG. 2 provides only an illustration of one implementation and does not imply any limitations with regard to the environments in which different embodiments may be implemented. Many modifications to the depicted environments may be made based on design and implementation requirements.

In another embodiment, risk-free walkway module 240 and package delivery module 250 may operate on more than one computer, server computer, or some combination of computers and server computers, for example, a plurality of computers communicating across the network with a single server computer. In another embodiment, for example, risk-free walkway module 240 and package delivery module 250 may operate on a plurality of server computers communicating across the network with a plurality of client computers. Alternatively, risk-free walkway module 240 and package delivery module 250 may operate on a network server communicating across the network with server 210 and a plurality of client computers.

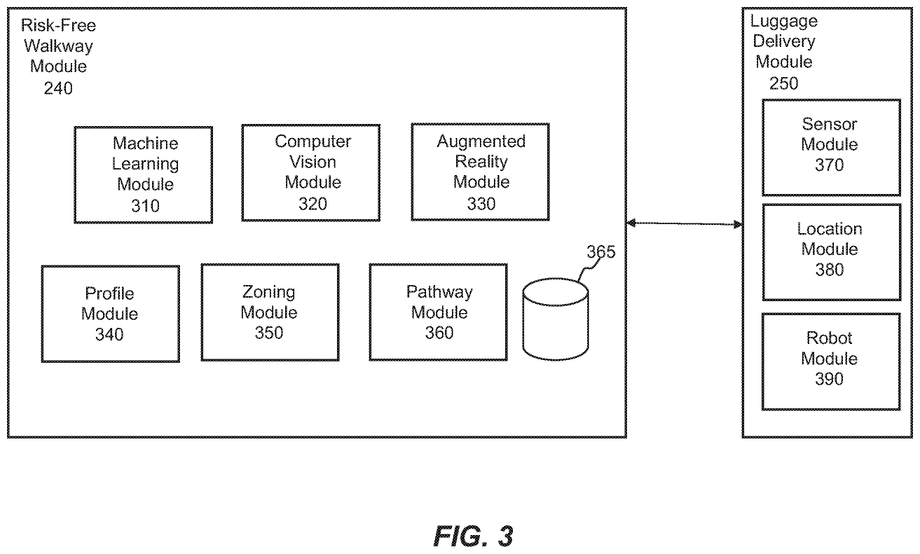

Referring now to FIG. 3, an example architecture 300 of risk-free walkway module 240 and package delivery module 250 is depicted, according to an exemplary embodiment. In some embodiments, risk-free walkway module 240 comprises a machine learning module 310, a computer vision module 320, an augmented reality (“AR”) module 330, a profile module 340, a zoning module 350, a pathway module 360, and risk-free walkway module database 365. It should be noted that machine learning module 310, computer vision module 320, augmented reality module 330, profile module 340, zoning module 350, and walkway module 360 are communicatively coupled over the network, and may function in unison in order to generate risk-free walkways for user 230 configured to be stored in risk-free walkway module database 365. Package deliver module 250 comprises a sensor module 370, a location module 380, and a robot module 390.

Machine learning module 310 is configured to use one or more heuristics and/or machine learning models for performing one or more of the various aspects as described herein. In some embodiments, the machine learning models may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. In particular, machine learning module 310 is configured to utilize data collected by one or more of server 210, computing device 235, sensor module 370, etc. as training data sets in order for machine learning module 310 to generate one or more predictions pertaining to delivery of packages by robot module 390. For example, predictions pertaining to a destination of a venue where and in what manner user 230 is to receive a package (e.g., luggage retrieval area at a transportation hub, etc.)

Computer vision module 320 is configured to utilize algorithms or techniques that identify and process objects in images and videos. In particular, computer vision module 320 receives computer vision data including images and videos from one or more of server 210, sensor module 370, or any other applicable sources for images and videos associated with a venue and/or user 230 (e.g., monitoring system, security system, etc.). Computer vision trains computers to interpret and understand the received data such as digital image and/or video content, and can include techniques such as machine learning and/or use of machine learning models such as deep learning models (provided by machine learning module 310) to accurately identify and/or classify objects, and possibly react to what it identifies. In some embodiment, one or more computer vision algorithms can break or decompose the original region (images of) into smaller parts, classifying the smaller parts with simpler concepts. One or more computer vision algorithms can also retrieve or receive similar images. In an embodiment, one or more knowledge augmented machine learning algorithms generated by machine learning module 310 can automatically annotate regions. Acquired knowledge about concepts can be used to search for candidate regions to be annotated. In particular, the aforementioned assists with the classification of contaminated zones within the venue based on data collected by one or more of server 210, sensor module 370, and risk-free walkway module 240. Contaminants on an entity or within a venue are detected using any combination of sensor data, one or more images, and one or more contamination propagation patterns. Machine learning module 310 and computer vision module 320 receive inputs of sensor data, the one or more images, and the one or more contamination propagation patterns, while the outputs are the determination of contamination zones, along with the locations of different types and levels of contamination.

AR module 330 is configured to render and map augmented reality content in a defined virtual space for presentation to user 230 via computing device 235 in the instance where computer device 235 is a computer-mediated reality device. For example, AR module 330 communicates with one or more sensors associated with sensor module 370 and/or computing device 235 in order to track the real position and orientation of user 230, define the virtual space surrounding user 230, and visually designate contaminated zones, paths, obstacles, destinations where to receive packages from robot module 390, etc. based on predictions ascertained from machine learning module 310 and computer vision module 320.

Profile module 340 is configured to generate and maintain the user profile of user 230, in which the user profile may be utilized by AR module 330 to generate AR content specifically tailored to user 230, and luggage delivery module 250 may also utilize user data derived from the user profile in order for robot module 390 to deliver efficiently deliver packages to user 230. Information such as geo-location, traveler data (e.g., trip itineraries, record locators, confirmation codes, etc.), traveler credentials (e.g., frequent flyer program benefits, expedited check-in, lounge access, etc.), social media activity, browsing activity, AR depiction preferences (e.g., brightness, notification frequency, overlaid presentation preference, etc.), etc. may be ascertained from the user profile. For example, traveler information of user 230 derived from the user profile may be utilized by robot module 390 in order to verify user 230 resulting in robot module 390 unlocking and releasing luggage to user 230 at the proper retrieval destination subject to identify confirmation. In some embodiments, data from the user profile is utilized in order for risk-free walkway module 250 to assign a priority to the generated risk-free walkway which includes a destination for user 230 to receive one or more packages from robot module 390. Assignment of a priority allows risk-free walkways to be scheduled in priority-based order preventing overlapping, clustering, and/or intersecting of risk-free walkways generated for multiple users.

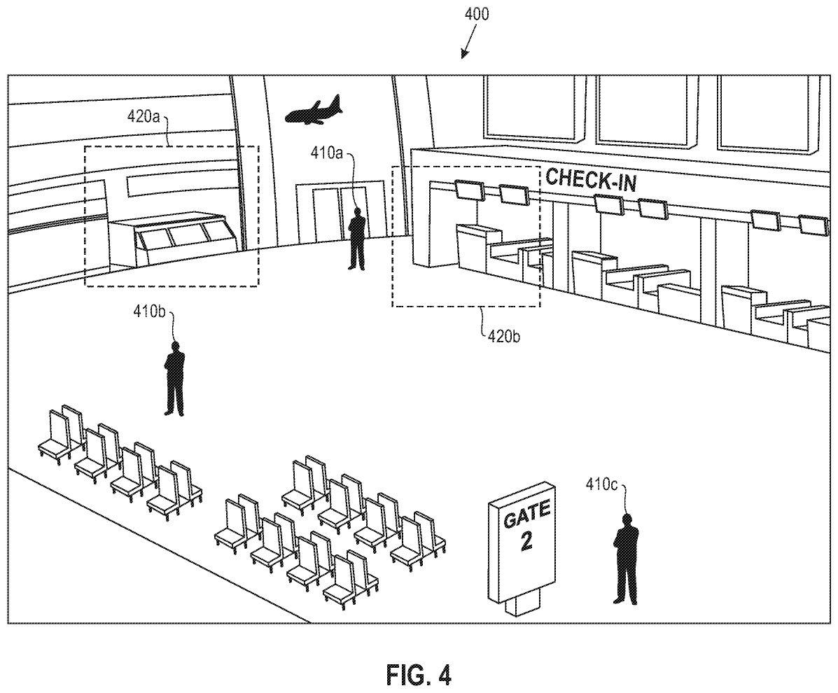

Zoning module 350 is configured to designate areas within the applicable venue as contaminated zones based upon analyses of data acquired from one or more of one or more of server 210, computing device 235, sensor module 370. For example, ultraviolet visible spectroscopy derived data collected by one or more sensor systems associated with sensor module 370 indicates presence of contamination within an area associated with the venue in which zoning module 350 classifies the area as a contaminated zone that must be circumvented via the risk-free walkway and delivery of the package. Particulars regarding zoning are described in greater details in reference to FIG. 4.

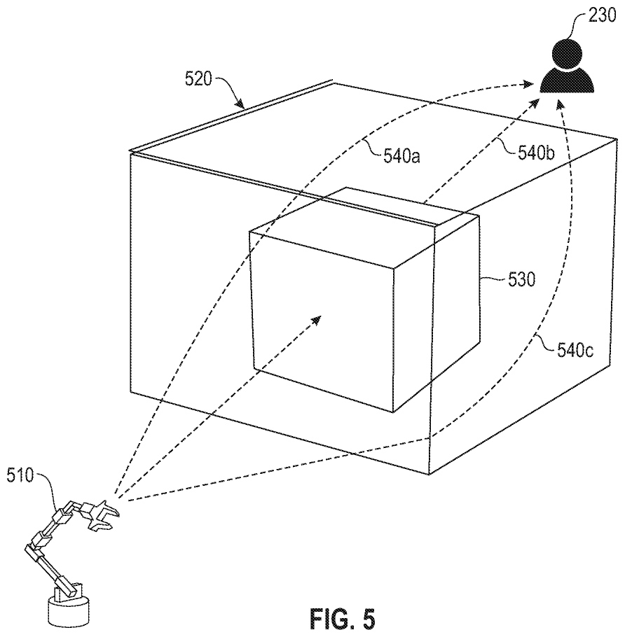

Pathway module 360 is designed to generate the risk-free walkways based on data collected from any of the aforementioned modules of risk-free walkway module 250. Essentially, pathway module 360 is configured to function as an overlay program designed to account for map data associated with the venue including detailed map information corresponding to areas that user 230 and/or one or more robots of robot module 390 traverse through. Pathway module 360 generates a virtual pathway that is overlaid on the map data in which the virtual pathway is provided to user 230 via the view of computing device 235 when some or all of the path is within the real-world direction and incline view of the display associated with computing device 235. In addition, map data may be consistently updated via location module 380 which is consistently acquiring information pertaining to the applicable venue or location user 230 or the one or more robots are traversing within. In some embodiments, pathway module 360 generates risk-free walkways for robots of robot module 390 to ensure that the robots arrive to user 230 in a manner that circumvents contamination zones and delivers packages to user 230 in at least one classified uncontaminated zone. The position of the path of the risk-free walkway is determined relative to the position of the applicable robot ascertained from robot module 390 and details derived from the map data ascertained from location module 380. The map data may further include topography and features of the area to be traversed which, in some embodiments, may include, terminals, baggage claim, trails, paths, forest areas, moving water, water crossings, tree lines, rocky areas, open fields, roads, parks, campsites, sources of drinking water, and nearest point of help or assistance. Information relating to the generation of risk-free walkways is discussed in greater detail in reference to FIG. 5.

Sensor module 370 is designed to a receive a plurality of sensor data associated with user 230 and the location/venue for analysis performed by risk-free walkway module 240. The sensor systems associated with sensor module 370 may include various types of sensors including, but are not limited to cameras, microphones, internet-of-things (IOT) sensors, weight scales, gas detectors, humidity sensors, accelerometers, gyroscopes, barometers, GPS sensors, thermometers, ultra-violet (UV) sensors, haptic sensors, biological-based sensors, or any other applicable sensors known to those of ordinary skill in the art. One purpose of sensor module 370 is to not only collect map data and environment data associated with the venue, but also communicate with robot module 390 in order to track location and movement of the robots for delivering the packages.

Location module 380 is configured to generate a location profile associated with the venue based on analyses of sensor data relating to the venue. Location module 380 is also tasked with managing coordination of the delivery of luggage by the robots based on detected occupancy of the venue, risk-free walkways of users provided by risk-free walkway module 240, and any other applicable factors ascertainable from sensor data associated with the venue. For example, the internal temperature, statistics/analytics pertaining to occupancy of the venue, contamination readings of detected infectious zones, etc. may be determined based on analyses derived from the location profile. Location profiles may further include a length of each conveyor belt within the venue, an amount of required time to deliver packages, and an amount of required time for the user to collect packages from a package receiving location within the venue (e.g., baggage claim, etc.). In some embodiments, risk-free walkways module 240 is configured to utilize machine learning models including training datasets comprising data derived from the location profile to perform predictions (e.g., using computer vision techniques and convolutional neural networks).

Robot module 390 is configured to manage a plurality of robots designed to function as carriage to transfer packages to users upon users reaching the applicable destination within the venue. Robot 510 is a machine that is capable of carrying out a series of actions automatically. Robot 510 can be an autonomous machine or can be controlled by a human operator. Robot 510 can be equipped with various sensors (e.g., camera, radar, proximity, etc.) which can be used for navigation and/or collection information from the surrounding environment. The plurality of robots are machines that are capable of carrying out a series of actions automatically. In particular, the plurality of robots are designed to transport packages to users within the venue according to an assigned risk-free pathway that circumvents the robot from interacting with contaminated zones detected by zoning module 350. The robots can be an autonomous machine or can be controlled by a human operator, and can be equipped with various sensors (e.g., camera, radar, proximity, etc.) which can be used for navigation and/or collection information from the surrounding environment. In some embodiments, a sensor system associated with sensor module 370 is embedded within one or more of the robots allowing sensor data associated with one or more of the user 230, the venue, and the robots. One purpose of a sensor system being embedded within one or more of the robots is to acquire data pertaining to the venue and the risk-free walkways in real-time as the robots traverse the location; thus, allowing zoning module 350 and pathway module 360 to modify and update classification of contaminated zones/uncontaminated zones and risk-free walkways, respectively. Furthermore, data acquired from the sensor data derived from the sensor system of the robots may be transmitted to location module 380 in order to update the location profile.

Robot module 390 is further configured to manage a security mechanism designated for the one or more robots, in which the security mechanism has a lock feature and unlock feature. The lock feature is designed for the robots to retain the package of user 230 in a fastened and secure manner until the robots reach the applicable destination (e.g., endpoint of the risk-free walkway, baggage claim, luggage retrieval area, etc.), and upon confirmation of identity provided by user 230 at the applicable destination robot module 390 initiates instructions to activate the unlock feature resulting in the release of the package(s) to user 230. Confirmation of the identity may accomplished via providing travelers information (e.g., flight confirmation code, reservation code), a scannable QR code generated by location module 380 based on data derived from the user profile, biometrics with consent given by user 230 (e.g., fingerprint, iris scan, facial detection, etc.), or any other applicable form of secure identity confirmation known to those of ordinary skill in the art. In some embodiments, robot module 390 supports a guiding feature comprising instruction that enable the robots to guide user 230 along the applicable route of the risk-free walkway generated by pathway module 360 to the applicable destination of the risk-free walkway, in which user 230 may manually retrieve packages from the baggage claim or utilize the aforementioned unlocking feature of the robot delivery.

Referring to FIG. 4, a virtually zoned environment 400 within an airport is depicted, according to an exemplary embodiment. Virtual zoned environment 400 illustrates a physical environment including a plurality of groups 410a, 410b, and 410c in which each of the groups are assigned to one of virtual zone 420a and virtual zone 420b generated by zoning module 350, which may be a destination for luggage retrieval, a detected uncontaminated zone, a waiting area, a haven, etc. As previously mentioned, the assignment of groups 410a, 410b, and 410c may be based on the user profile of each individual within groups 410a, 410b, and 410c, or the location profile. In some embodiments, the assignments may further be based on overlapping of routes of risk-free walkways ascertained by the robots that would likely result in collisions among robots, travelers, and/or overall interactions with contaminated zones. For example, it may be ascertained from the user profiles or location profile that the luggage of two distinct users are arriving at baggage claim at the same or significantly close times which would result in an influx of individuals at the baggage claim area; however, assignment of priority to risk-free walkways allows overlapping of risk-free walkways to be circumvented by assigning risk-free walkways that ensure that routes of users do not cross and that risk-free walkways are assigned with adequate timing between them. In some embodiments, virtually zoned environment 400 is designed to represent an augmented version of a physical space depicted via computing device 235; however, virtual zone 420a and virtual zone 420b may be made visible to user 230 via interfaces provided on the centralized platform (e.g., venue maps, redzones indicating contamination of a zone, visual indicators of safe spaces, etc.) in the instance in which computing device 235 is not a computer-mediated reality device. For example, virtual zone 420a and virtual zone 420b are geo-fenced areas delineated on one or more maps of the venue presented via the centralized platform creating a distinction between the routes of the risk-free walkway and virtual zones 420a and 420b. In some embodiments, virtual zones 420a and 420b may be assigned to groups to serve as check-in areas at transportation hubs (e.g., airports, train stations, bus stations, etc.) waiting areas, and/or havens for the group. In the instance in which virtual zones 420a and/or 420b serve as check-in points, robot module 390 may instruct a robot to retrieve package(s) from user 230 by requesting the package(s) in an unlocked state and upon user 230 providing the packages to the robot along with a form of identity confirmation (e.g., travelers information, biometrics, etc.), the robot retains the package(s) in the locked position and delivers to the appropriate destination.

User 230 may be provided the functionality of ascertaining their position within the venue in real-time in reference to the contaminated regions and virtual zone that has been assigned to them, which may be depicted via interfaces provided by the centralized platform. In some embodiments, assignment of the virtual zones allows for zoning module 350 to determine one or more geofences that are designed to separate contaminated zones from virtual zones in a manner in which while user 230 and/or the applicable robot is traversing along the risk-free walkway, risk-free walkway module 240 is alerting user 230 of their proximity to the boundaries of the geofence in order to prevent potential exposure to risks along routes.

Referring to FIG. 5, a risk-free walkway method 500 generated by risk-free walkway module 240 is depicted, according to an exemplary embodiment. In some embodiments, risk-free walkway method 500 is a depiction of risk-free walkway routes 530a, 530b, and 530c calculated by pathway module 360, in which the detected one or more contaminated regions 530 in a physical environment 520 are derived from sensor data pertaining to the venue accounted for in the location profile. As previously mentioned, risk-free walkways are designed to guide user 230 and/or a robot 510 associated with robot module 390 to a destination 540 within physical environment 520. In some embodiments, robot module 390 utilizes existing techniques known in the art of object identification based on video/graphics analysis (e.g., Mixture of Gaussian models, Wavlet decomposition, etc.) acquired while robot 510 traverses the risk-way walkway or during overall traversing within the venue. For example, robot 510 can identify contamination in real-time within the venue and send the acquired sensor data to risk-free walkway module 240. Destination 540 may be an arrival area, baggage claim, or any other applicable location configured for user 230 to retrieve package(s) or robots to deliver package(s) to user 230. In some embodiments, risk-free walkway module 240 prioritizes routes 530a, 530b, and 530c based on computed risk-scores of routes 530a, 530b, and 530c, in which the computations of the scores account for factors such as but not limited to capacity of venue, level of contamination of areas within the venue, travelers' information (e.g., arrival time, assigned baggage claim location, etc.), or any other applicable factor necessary to allocate priority. For example, computation of risk-scores associated with routes 530a, 530b, and 530c may account for route availability, space density within the venue, group specific prioritization (e.g., credentials for expediting, etc.), risk-propagation scores generated by machine learning module 310, time windows, etc. In some embodiments, risk-scores are derived from outputs of the machine learning models of machine learning module 310 based on acquired sensor data from the applicable sensor system. Ranking may be applied to the priority of a group and their assigned virtual zone based on analyses of one or more of the user profile, location profile, and/or sensor data received from the applicable sensor system. The ranking of the priority may further be utilized for calculating an amount of time for robot module 390 to accomplish delivery of packages to user 230. For example, user 230 may be presented routes 530a, 530b, and 530c on computing device 235 in which the calculated delivery time for route 530a is the fastest because the calculated risk score associated with 530a factors priority status of user 230, proximity of assigned virtual zone from contaminated zones circumvented via the route, probability of collision with risk-free walkways of other users, etc.

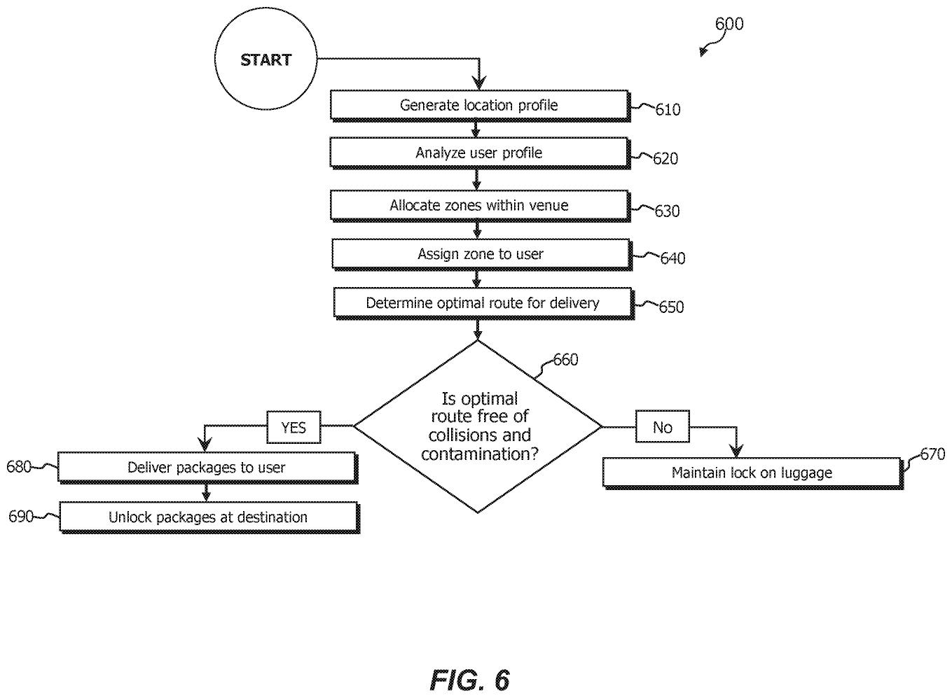

With the foregoing overview of the example architecture, it may be helpful now to consider a high-level discussion of an example process. FIG. 6 depicts a flowchart illustrating a computer-implemented process 600 for delivering package in a risk-free walkway, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, location module 380 generates a location profile associated a location. Generation of the location profile is based on not only analyses of sensor data received from one or more of the sensor system and the robots traversing the venue, but also location data collected by server 210 including but not limited to map data, security updates of the venue, venue-specific restrictions, national traveling advisories, weather updates, and any other applicable type of data configured to ascertained by web crawlers. The location profile may further account for areas within the venue that are designated for travelers to receive package(s) (e.g., luggage, suitcases, etc.) such as baggage claim, and the scheduling of releasing of packages to said designated areas. Location profile may further account for predictions generated by machine learning module 310 that relate to contamination zones, congested areas, etc. based on historical sensor data obtained by the applicable sensor systems.

At step 620 of process 600, risk-free walkway module 240 analyze the user profile. One major purpose of the user profile is to account for traveler information that may be taken into consideration when determining risk-free pathways, assigned priority, contaminated zones, allocated geo-fences, etc. In particular, one or more components of traveler information (e.g., flight confirmation code, baggage tag ID number, etc.) may be ascertained from the user profile in order to verify user 230 during the process of checking in and providing the robot with the package(s), or during the process of retrieving the package(s) in which the traveler information may be requested by robot module 390 in order to transition from a locked mode to an unlocked mode designed to release the package(s).

At step 630 of process 600, zoning module 350 defines virtual zones within the venue. In some embodiments, assignment of virtual zones is based on one or more outputs of the machine learning models that utilized training data sets include the collected sensor data. For example, collected sensor data may indicate areas within the venue that are highly contaminated and that are contamination free resulting in virtual zones being allocated to users accordingly. As previously mentioned, virtual zones may be a destination for luggage retrieval, a detected uncontaminated zone, a waiting area, a haven, etc.

At step 640 of process 600, zoning module 350 assigns a virtual zone to user 230. Assignment of the virtual zone to user 230 may be based upon various factors including but not limited to data derived from the user profile, location profile, outputs of the machine learning models, risk-scores assigned to the routes of risk-free walkways, priority of the user and/or group, etc. In some embodiments, zoning module 350 progressively updates the designation of virtual zones and the assigning of virtual zones to groups based upon subsequent processing performed on the continuously received sensor data. For example, a virtual zone may be re-assigned due to the processing of the sensor data indicating that a virtual zone as transitioned from a non-contaminated zone to a contaminated zone. The virtual zones may be overlayed on map data associated with the venue configured to be viewed on the centralized platform via computing device 235.

At step 650 of process 600, pathway module 360 determines the optimal path of delivery. Although each of the routes of the risk-free walkway are allocated a risk-score based upon various factors, one primary purpose of determining an optimal path is to ensure that user 230 and/or the applicable robot traverses the route that circumvents contamination zones and other applicable risks that may be encountered while traversing the route (e.g., other travelers, high congestion, etc.) in the least amount of time. In some embodiments, the determination of the optimal path for user 230 is provided based on the priority of user 230 relative to other travelers. For example, a particular route of a risk-free walkway may be the determined optimal path for delivery of packages due to another traveler with a higher priority that has a significant amount of luggage that would require additional time for the robots to deliver.

At step 660 of process 600, pathway module 360 analyzes whether the optimal route is free of collisions and contamination. If not, then step 670 of process 600 occurs in which robot module 390 holds the package(s) in a waiting mode operated by robot module 390 configured to maintain the locked feature on the applicable robot preventing the package from being released until the robot is able to deliver the packages at the destination of the route in a manner free of collisions with other travelers and robots and with minimal exposure to contaminated zones. In some embodiments, the robot allocated to the user or group to guide the party to the destination of the route may execute the waiting mode operated by robot module 390 that allows traffic within the venue to subside in order to circumvent collisions and exposure to contaminated zones. Otherwise, step 680 of process 600 occurs in which robot module 390 instructs robot 510 to deliver packages to user 230. It should be noted that packages may be delivered to user 230 by robot module 390 executing instructions to robot 510 to transport the packages to user 230 at the destination of the selected route of the risk-free walkway or robot 510 may guide user 230 to the destination where packages are to be collected within the venue (e.g., baggage claim, etc.).

At step 690 of process 600, robot module 390 instructs robot 510 to activate the unlock feature; thus, releasing the packages to user 230. In some embodiments, robot 510 requests identity confirmation from user 230 which may be accomplished by user 230 providing travelers information (e.g., confirmation code, record locator, etc.), biometric data in which robot 510 may support features to scan and/or process biometric data (e.g., iris scanner, fingerprint scanner, etc.), user 230 entering confirmation data on one or more interfaces presented via the centralized platform, or any other applicable mechanism configured to confirm the identity of a user known to those of ordinary skill in the art.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for delivering packages in a risk-free walkway comprising:
generating, by a computing device, a location profile associated with a location;
analyzing, by the computing device, a user profile associated with a user;
determining, by the computing device, an optimal path for delivery of packages associated with the user based on the location profile; and
deploying, by the computing device, a robot designed to utilize the optimal path to deliver package based on the user profile.

2. The computer-implemented method of claim 1, wherein generating the location profile comprises:
receiving, by the computing device, a plurality of sensor data associated with the location;
wherein the plurality of sensor data comprises at least contamination data indicating the presence of contamination of one or more areas within the location.

3. The computer-implemented method of claim 1, wherein the user profile comprises at least travel data associated with the user.

4. The computer-implemented method of claim 1, wherein determining the optimal path for delivery of package comprises:
defining, by the computing device, a plurality of zones within the location based on the location profile; and
assigning, by the computing device, the user to at least one zone of the plurality of zones;
wherein at least one zone of the plurality of zones is associated with a risk-free walkway associated with the user within the location free of contamination.

5. The computer-implemented method of claim 4, wherein deploying the robot further comprises:
unlocking, by the computing device, a security lock mechanism of the robot at the at least one zone in response to a verification of the user profile;
wherein unlocking the security lock mechanism allows the package to be released to the user within the at least one zone.

6. The computer-implemented method of claim 2, wherein the location profile comprises one or more of a length of each conveyor belt within the location, an amount of required time to deliver packages, and an amount of required time for the user to collect packages from a package receiving location.

7. The computer-implemented method of claim 1, wherein determining the optimal path for delivery of package further comprises:
determining, by the computing device, a priority of package delivery based on the location profile; and
calculating, by the computing device, an amount of time for package delivery based on the priority determination.

8. A computer program product for delivering packages in a risk-free walkway, the computer program product comprising a computer readable storage medium having program instructions embodied therewith, wherein the computer readable storage medium is not a transitory signal per se, the program instructions being executable by a processor to cause the processor to perform a method comprising:
generating a location profile associated with a location;
analyzing a user profile associated with a user;
determining an optimal path for delivery of packages associated with the user based on the location profile; and
deploying a robot designed to utilize the optimal path to deliver package based on the user profile.

9. The computer program product of claim 8, wherein generating the location profile comprises:
receiving a plurality of sensor data associated with the location;
wherein the plurality of sensor data comprises at least contamination data indicating the presence of contamination of one or more areas within the location.

10. The computer program product of claim 8, wherein the user profile comprises at least travel data associated with the user.

11. The computer program product of claim 8, wherein determining the optimal path for delivery of package comprises:
defining a plurality of zones within the location based on the location profile; and
assigning the user to at least one zone of the plurality of zones;
wherein at least one zone of the plurality of zones is associated with a risk-free walkway associated with the user within the location free of contamination.

12. The computer program product of claim 11, wherein deploying the robot further comprises:
unlocking a security lock mechanism of the robot at the at least one zone in response to a verification of the user profile;
wherein unlocking the security lock mechanism allows the package to be released to the user within the at least one zone.

13. The computer program product of claim 9, wherein the location profile comprises one or more of a length of each conveyor belt within the location, an amount of required time to deliver packages, and an amount of required time for the user to collect packages from a package receiving location.

14. The computer program product of claim 9, wherein determining the optimal path for delivery of package further comprises:
determining a priority of package delivery based on the location profile; and
calculating an amount of time for package delivery based on the priority determination.

15. A computer system for delivering packages in a risk-free walkway, the computer system comprising:
one or more processors;
one or more computer-readable memories;
program instructions stored on at least one of the one or more computer-readable memories for execution by at least one of the one or more processors, the program instructions comprising:
program instructions to generate a location profile associated with a location;
program instructions to analyze a user profile associated with a user;
program instructions to determine an optimal path for delivery of packages associated with the user based on the location profile; and
program instructions to deploy a robot designed to utilize the optimal path to deliver package based on the user profile.

16. The computer system of claim 15, wherein program instructions to generate the location profile comprise:
program instructions to receive a plurality of sensor data associated with the location;
wherein the plurality of sensor data comprises at least contamination data indicating the presence of contamination of one or more areas within the location.

17. The computer system of claim 15, wherein program instructions to determine the optimal path for delivery of package comprise:
program instructions to define a plurality of zones within the location based on the location profile; and
program instructions to assign the user to at least one zone of the plurality of zones;
wherein at least one zone of the plurality of zones is associated with a risk-free walkway associated with the user within the location free of contamination.

18. The computer system of claim 17, wherein program instructions to deploy the robot further comprise:
program instructions to unlock a security lock mechanism of the robot at the at least one zone in response to a verification of the user profile;
wherein unlocking the security lock mechanism allows the package to be released to the user within the at least one zone.

19. The computer system of claim 16, wherein program instructions to determine the optimal path for delivery of package further comprise:
program instructions to determine a priority of package delivery based on the location profile; and
program instructions to calculate an amount of time for package delivery based on the priority determination.

20. The computer system of claim 16, wherein the location profile comprises one or more of a length of each conveyor belt within the location, an amount of required time to deliver packages, and an amount of required time for the user to collect packages from a package receiving location.
